(19) United States
(12) Patent Application Publication
(10) Pub. No.: US 2024/0110289 A1
(43) Pub. Date: Apr. 4, 2024

(54) PLANT FOR GENERATING RESOURCES FROM SOIL ON LUNAR SURFACE AND OPERATION METHOD THEREOF

(71) Applicant: JGC CORPORATION, Kanagawa (JP)

(72) Inventors: Yoshitoki TANAKA, Kanagawa (JP); Kiho FUKAURA, Kanagawa (JP); Soichi MORI, Kanagawa (JP)

(73) Assignee: JGC CORPORATION, Kanagawa (JP)

(21) Appl. No.: 18/275,398

(22) PCT Filed: Mar. 25, 2021
(86) PCT No.: PCT/JP2021/012458

§ 371 Date: Aug. 1, 2023

(51) Int. Cl. C25B 1/04

(52) U.S. Cl. CPC C25B 1/04

(57) ABSTRACT

Provided is a plant for generating resources from soil on a lunar surface, including: a water extraction unit configured to extract water from a water-containing regolith in the soil; an electrolyzing unit configured to generate hydrogen and oxygen by electrolysis of water; and a reducing unit configured to reduce metal oxide contained in the soil with hydrogen.

### TECHNICAL FIELD

The present invention relates to a plant for generating resources from soil on a lunar surface and an operation method thereof.

### BACKGROUND ART

In Patent Literature 1, there is described a synthetic lunar substance production method including the steps of, for example, separating a rich feed that is rich in ilmenite by beneficiation of a lunar feed substance, reducing the rich feed with a hydrogen-containing gas to generate water and a metal of iron or titanium, and electrolyzing the generated water to generate hydrogen and oxygen.

The moon has a gravity smaller than that of the earth, and hence the atmosphere on the lunar surface is extremely thin. Because of this, in order for human beings to be active on the lunar surface, it is desired that substances formed of light elements, such as hydrogen, oxygen, and water, be stably available.

In the sections regarding the prior art and objects in Patent Literature 1, there are raised an issue of providing an apparatus for producing oxygen and by-products on the lunar surface through use of a minimum amount of materials transported from the earth in order to obtain oxygen required for life support, and the like. In addition, in the section of the action in Patent Literature 1, it is stated that the net consumption of hydrogen does not occur due to factors other than the leakage, as in the case of other earth derived reagents.

However, hydrogen that is indispensable for implementing the production method disclosed in Patent Literature 1 is positioned as a material transported from the earth. In the production method disclosed in Patent Literature 1, regarding hydrogen, it is assumed that hydrogen is repeatedly circulated between the step of reducing a metal oxide, such as ilmenite, which can be collected on the lunar surface with hydrogen and the step of electrolyzing the water thus generated to generate hydrogen and oxygen. As means for supplying hydrogen to this circulation system, no method other than transportation from the earth has been suggested.

### CITATION LIST

### Patent Literature

[PTL 1] JP 3-271102 A

### SUMMARY OF INVENTION

### Technical Problem

An object of the present invention is to provide, in a plant for generating resources from soil on a lunar surface and an operation method thereof, a plant capable of supplying hydrogen and circulating the hydrogen as a resource on the lunar surface and an operation method thereof.

### Solution to Problem

According to a first aspect of the present invention, there is provided a plant for generating resources from soil on a lunar surface, including: a water extraction unit configured to extract water from a water-containing regolith in the soil; an electrolyzing unit configured to generate hydrogen and oxygen by electrolysis of water; and a reducing unit configured to reduce metal oxide contained in the soil with hydrogen.

According to a second aspect of the present invention, there is provided the plant according to the first aspect, further including a fuel cell configured to generate electric power from hydrogen and oxygen.

According to a third aspect of the present invention, there is provided the plant according to the first aspect or the second aspect, further including a power generation facility.

According to a fourth aspect of the present invention, there is provided the plant according to any one of the first aspect to the third aspect, including a control unit configured to control the plant based on at least one of a demand amount or a supply amount regarding at least one kind selected from water, oxygen, hydrogen, and electric power.

According to a fifth aspect of the present invention, there is provided the plant according to the fourth aspect, in which the control unit controls the plant in consideration of an amount of oxygen required for a chemical reaction between hydrogen and oxygen and an amount of oxygen required for life support on the lunar surface regarding at least one of the demand amount or the supply amount of oxygen.

According to a sixth aspect of the present invention, there is provided the plant according to the fourth aspect or the fifth aspect, in which the control unit controls the plant in consideration of an amount of hydrogen required for a chemical reaction between hydrogen and oxygen and an amount of hydrogen required for reduction of the metal oxide regarding at least one of the demand amount or the supply amount of hydrogen.

According to a seventh aspect of the present invention, there is provided the plant according to the fourth aspect, in which the control unit decides to use a whole amount of water supplied from the reducing unit for the electrolysis when a remaining amount of stored water is sufficient, and decides to extract water from the water-containing regolith when the remaining amount of the stored water is insufficient.

According to an eighth aspect of the present invention, there is provided an operation method of a plant for generating resources from soil on a lunar surface, including: extracting water from a water-containing regolith in the soil; generating hydrogen and oxygen by electrolysis of water containing at least the water extracted from the water-containing regolith; and reducing metal oxide contained in the soil with the hydrogen generated by the electrolysis.

According to a ninth aspect of the present invention, there is provided the operation method of a plant according to the eighth aspect, in which the plant is controlled based on at least one of a demand amount or a supply amount regarding at least one kind selected from water, oxygen, hydrogen, and electric power.

### Advantageous Effects of Invention

According to the first aspect, water is extracted from the water-containing regolith that can be collected from the soil on the lunar surface, and hydrogen can be generated on the lunar surface by the electrolysis of water. As a result, the hydrogen can be supplied and circulated as a resource on the lunar surface.

According to the second aspect, the hydrogen and oxygen obtained by the electrolysis of water can be converted into electric power to provide energy.

According to the third aspect, the electric power that is energy in a form which is easily utilized in the plant can be efficiently obtained. Through combination of the third aspect and the second aspect, the electric power can be physically stored in a form of hydrogen and oxygen.

According to the fourth aspect, hydrogen, oxygen, and water that are substances formed of light elements which are not easily available on the lunar surface, or the electric power that is general-purpose energy can be easily managed.

According to the fifth aspect, the plant can be effectively operated in consideration of the balance between the hydrogen and oxygen that are available as a storage form of energy and the oxygen for life support required for activities on the lunar surface.

According to the sixth aspect, the plant can be effectively operated in consideration of the balance between the hydrogen and oxygen that are available as a storage form of energy and the hydrogen that is available as a raw material for obtaining water.

According to the seventh aspect, the resource of the water-containing regolith can be conserved for a longer period of time by decreasing the amount of water to be extracted from the water-containing regolith.

According to the eighth aspect, water is extracted from the water-containing regolith that can be collected from the soil on the lunar surface, and hydrogen can be generated on the lunar surface by the electrolysis of water. As a result, hydrogen can be supplied and circulated as a resource on the lunar surface.

According to the ninth aspect, hydrogen, oxygen, and water that are substances formed of light elements which are not easily available on the lunar surface, or the electric power that is general-purpose energy can be easily managed.

### BRIEF DESCRIPTION OF DRAWINGS

FIG. 1 is a conceptual diagram for illustrating an example of a plant for generating resources from soil on a lunar surface.

FIG. 2 is a conceptual diagram for illustrating an example of a control unit.

### DESCRIPTION OF EMBODIMENT

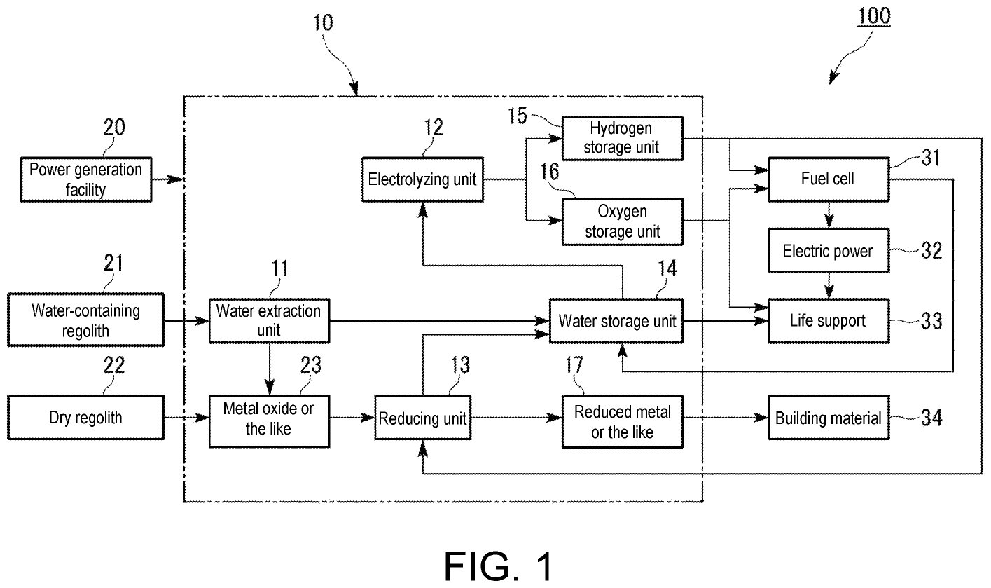

FIG. 1 is a conceptual diagram for illustrating an example of a plant for generating resources from soil on a lunar surface. A plant 100 of an embodiment includes: a water extraction unit 11 configured to extract water from a water-containing regolith 21 in soil on a lunar surface; an electrolyzing unit 12 configured to generate hydrogen and oxygen by electrolysis of water; and a reducing unit 13 configured to reduce metal oxide or the like 23 contained in the soil on the lunar surface with hydrogen.

The water-containing regolith 21 as well as a dry regolith 22 containing no water can be collected from the soil on the lunar surface. Water serving as a raw material for hydrogen on the lunar surface can be obtained by extracting water from the water-containing regolith 21 through use of the water extraction unit 11. A method of extracting water in the water extraction unit 11 is not particularly limited, but there is given a method involving volatilizing water from the water-containing regolith 21 by focused irradiation of sunlight, electric heat, or the like. The volatilized water can be condensed into a liquid or solidified into a solid by cooling. The water extraction unit 11 may obtain water by melting ice present on the dark side of the lunar surface in addition to water extraction from the water-containing regolith 21 by the above-mentioned method.

The water extracted from the water-containing regolith 21 may be stored in a water storage unit 14. The water storage unit 14 may be a container, such as a tank, capable of storing water. A state in which the water is stored in the water storage unit 14 is not particularly limited. The water may be stored in a state of a pure substance of water, such as a liquid phase, a gas phase, or a solid phase, or may be stored also in a state of, for example, being mixed with, adsorbed to, or absorbed by other material. Water other than the water extracted from the water-containing regolith 21 may be stored together in the water storage unit 14.

When water is electrolyzed through use of the electrolyzing unit 12, hydrogen and oxygen can be generated. The water to be treated in the electrolyzing unit 12 is not limited to the water extracted from the water-containing regolith 21, and may be water obtained from other step. An electrolyzer used in the electrolyzing unit 12 is not particularly limited, but for example, an electrolyzer including a solid electrolyte may be used. The water to be used for electrolysis may be in a liquid phase or a gas phase.

The hydrogen and oxygen generated by electrolysis of water may be stored in a hydrogen storage unit 15 and an oxygen storage unit 16, respectively. A state in which the hydrogen is stored in the hydrogen storage unit 15 is not particularly limited. The hydrogen may be stored in a state of a pure substance, such as a liquid phase, a gas phase, or a solid phase, or may be stored also in a state of, for example, being mixed with, adsorbed to, or absorbed by other material. A state in which the oxygen is stored in the oxygen storage unit 16 is not particularly limited. The oxygen may be stored in a state of a pure substance, such as a liquid phase, a gas phase, or a solid phase, or may be stored also in a state of, for example, being mixed with, adsorbed to, or absorbed by other material.

At least a part of the oxygen obtained by the electrolysis of water may be used for life support 33. As a facility for the life support 33, there is given a facility for activities of humans or animals living on the lunar surface. Carbon dioxide exhaled by respiration of humans or animals may be utilized for photosynthesis by plants, such as algae. With this configuration, oxygen consumed by the respiration can be regenerated by the photosynthesis.

At least a part of the hydrogen obtained by the electrolysis of water may be used for reduction of the metal oxide or the like 23. The metal oxide or the like 23 may be a remaining component obtained by extracting water from the water-containing regolith 21 or may be the dry regolith 22. The metal oxide or the like 23 may be sorted, heat-treated, or the like so as to increase the ratio of the metal oxide contained in the metal oxide or the like 23.

The plant 100 including at least the water extraction unit 11 and the electrolyzing unit 12 can extract water from the water-containing regolith 21, which is able to be collected from the soil on the lunar surface, and can generate hydrogen on the lunar surface by electrolysis. With this configuration, hydrogen can be supplied from a substance obtained on the lunar surface, and can be circulated as a resource. The plant 100 of the embodiment can be operated through use of only substances available from the lunar surface. At the time of start of the operation of the plant 100 or at a desired time, substances required for the operation of the plant 100 may be supplemented through use of hydrogen, oxygen, or water transported from the earth.

The reducing unit 13 can obtain a reduced metal or the like 17 by reducing the metal oxide or the like 23 through use of hydrogen. The hydrogen to be used in the reducing unit 13 is not limited to the hydrogen generated by electrolysis of water, and may be hydrogen obtained from other step. A method of reducing metal oxide in the reducing unit 13 is not particularly limited, but there is given a method involving heating metal oxide under the conditions including hydrogen by focused irradiation of sunlight, electric heat, or the like.

A device that heats the metal oxide or the like 23 in the reducing unit 13 and a device that heats the water-containing regolith 21 in the water extraction unit 11 may be different devices or may be the same device. When a reducing device for the metal oxide or the like 23 used in the reducing unit 13 and an extraction device used in the water extraction unit 11 are common in configuration, the configuration of the plant 100 can be simplified.

Examples of the metal oxide contained in the soil include a metal oxide, a multiple oxide, and a metal silicate. The metal oxide or the like 23 may contain components other than the metal oxide. Examples of the reduced metal obtained by reducing the metal oxide include iron (Fe), titanium (Ti), and silicon (Si). The reduced metal or the like 17 obtained by reducing the metal oxide from the metal oxide or the like 23 may contain components other than the reduced metal. The reduced metal or the like 17 can be used as a building material 34 or the like.

The hydrogen supplied to the reducing unit 13 generates water as a result of reduction of the metal oxide or the like 23. The water obtained in the reducing unit 13 can be supplied to the electrolyzing unit 12 through the water storage unit 14. When the plant 100 includes the electrolyzing unit 12 and the reducing unit 13, the hydrogen can be circulated between the electrolyzing unit 12 and the reducing unit 13.

When the amount of the water obtained in the reducing unit 13 is 2α mol and the amount of the water obtained in the water extraction unit 11 is 2β mol, the water storage unit 14 is supplied with (2α+2β) mol of water. When (2α+2β) mol of water is subjected to electrolysis, (2α+2β) mol of hydrogen and (α+β) mol of oxygen are obtained. In order to obtain 2α mol of water in the reducing unit 13, 2α mol of hydrogen is required. Because of this, it is preferred that, of (2α+2β) mol of hydrogen obtained by the electrolysis, at least 2α mol of hydrogen be supplied to the reducing unit 13. The ratio 2β:α+β between 2β mol of hydrogen that remains as a result and (α+β) mol of oxygen can be arbitrarily adjusted between 2:1 and 0:1 depending on the ratio of α:β.

The ratio of the hydrogen and the oxygen obtained by electrolysis of water to be used is not particularly limited, but hydrogen and oxygen may be used also at a molar ratio of 2:1. For example, when a fuel cell 31 is installed in the plant 100, electric power 32 can be generated from hydrogen and oxygen. The electric power 32 may be supplied as energy to a desired facility provided inside or outside the plant 100. For example, the electric power 32 can be supplied for the purpose of the life support 33.

The water supplied to the electrolyzing unit 12 is electrolyzed into hydrogen and oxygen. The fuel cell 31 generates water at the same time as obtaining the electric power 32 from hydrogen and oxygen. When the plant 100 includes the electrolyzing unit 12 and the fuel cell 31, hydrogen and oxygen can be circulated between the electrolyzing unit 12 and the fuel cell 31.

The plant 100 may further include a power generation facility 20. The energy source for the power generation facility 20 is not particularly limited. The energy source may be, for example, natural energy, such as sunlight, solar heat, or solar wind, or may be nuclear power, such as helium-3 (³He). Nuclear fusion, nuclear fission, or the like may be utilized for nuclear power, and fuel may be a substance obtained on the lunar surface or a substance transported from the earth.

For example, the electric power supplied from the power generation facility 20 may be used as the energy source for the electrolyzing unit 12. With this configuration, the electric power of the power generation facility 20 can be physically stored in the form of hydrogen and oxygen obtained by electrolysis of water.

The electric power obtained in the power generation facility 20 may be used in various parts of the plant 100. For example, the power generation facility 20 may supply the energy required for the operation of a substance conversion unit 10 including the water extraction unit 11, the electrolyzing unit 12, the reducing unit 13, and the like. The electric power obtained in the power generation facility 20 may be supplied to facilities other than the plant 100. The plant 100 may be supplied with electric power from the power generation facility 20 that does not belong to the plant 100.

A business entity that operates the power generation facility 20 may be the same as a business entity that operates the plant 100 or may be different therefrom. The installation place of the power generation facility 20 may be included in the installation range of the plant 100 or may be outside the installation range of the plant 100.

The hydrogen and oxygen obtained from the substance conversion unit 10 may be used not only for applications involving use with circulation of resources on the lunar surface but also for applications involving consumption of resources outside the system. For example, when hydrogen and oxygen are used as propellants for an object, such as a rocket, substances derived from the combustion of hydrogen and oxygen are released into outer space in order to propel the object. The ratio between hydrogen and oxygen for propulsion is not particularly limited, but may be, for example, a molar ratio of 2:0.75.

A method of controlling the plant 100 is not particularly limited. The plant 100 may be fully automatically controlled or may receive an instruction or operation by a human regarding at least some of items. When a human gives an instruction or operation to the plant 100, the operation may be performed from a site on the lunar surface or may be remotely performed from the lunar surface, earth, or outer space away from the plant 100.

When the plant 100 is operated at a site on the lunar surface, at least any one of the plant 100 or each unit, such as the water extraction unit 11, the electrolyzing unit 12, or the reducing unit 13, may include an operation unit. As required, the plant 100 or each unit thereof may be switchable between automatic control and manual operation. The instruction or operation by a human may be an instruction or operation for a control unit described later, or at least a part of the function of the control unit described later may be decided by a human.

It is preferred that the plant 100 include a control unit configured to control the plant 100 based on at least one of the demand amount or the supply amount regarding at least one kind selected from water, oxygen, hydrogen, and electric power. With this configuration, hydrogen, oxygen, and water that are substances formed of light elements which are not easily available on the lunar surface, or electric power that is general-purpose energy can be easily managed.

It is preferred that the input of the control unit include at least one kind selected from the demand amount of water, the supply amount of water, the demand amount of oxygen, the supply amount of oxygen, the demand amount of hydrogen, the supply amount of hydrogen, the demand amount of electric power, and the supply amount of electric power, but may include other parameters. The control unit may include, for example, an electronic circuit having a program. The control unit may include a memory device as required. The memory device may be achieved through use of, for example, a semiconductor memory, a magnetic hard disk, or the like.

The control unit may automatically acquire the above-mentioned input parameters to autonomously perform control, or may receive an instruction or operation by a human from outside to perform control. When the control unit receives an instruction or operation by a human to perform control, it is preferred that the plant 100 include communication means for enabling remote operation from the lunar surface, earth, or outer space away from the plant 100. The communication means may be wireless or at least partially wired. As the communication means, there are given a transmitting device and a receiving device, or one of the transmitting device and the receiving device.

When at least one of the demand amount of oxygen or the supply amount of oxygen is taken into consideration by the control unit, the amount of oxygen required for the chemical reaction between hydrogen and oxygen and the amount of oxygen required for the life support on the lunar surface may be taken into consideration. In addition, when at least one of the demand amount of hydrogen or the supply amount of hydrogen is taken into consideration by the control unit, the amount of hydrogen required for the chemical reaction between hydrogen and oxygen and the amount of hydrogen required for reduction of metal oxide may be taken into consideration. As a facility that performs the chemical reaction between hydrogen and oxygen, there is given the fuel cell 31 described above, but the facility is not limited thereto.

The supply of oxygen is limited on the lunar surface without atmosphere. Further, oxygen is indispensable for the support of life that requires oxygen respiration. For this reason, in the control unit, the demand amount or supply amount of hydrogen or oxygen for the chemical reaction between hydrogen and oxygen and the demand amount or supply amount of hydrogen or oxygen for other applications are separately taken into consideration, and thus the plant can be effectively operated in consideration of the balance between the hydrogen and oxygen available in the form of storage of energy and the other applications. The amount of hydrogen required for reducing metal oxide can be understood as the amount of hydrogen available as a raw material for obtaining water.

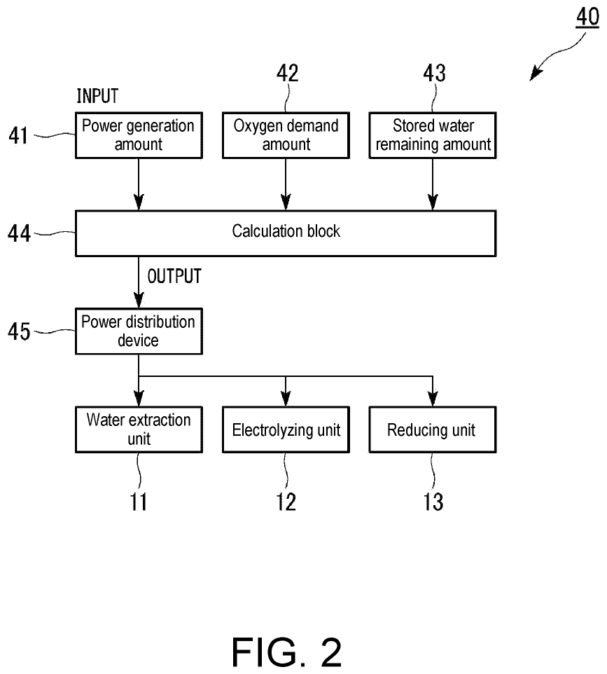

In FIG. 2, there is illustrated an example of the control unit. In a control unit 40, as input (INPUT) parameters, a power generation amount 41 that is an example of the supply amount of electric power, an oxygen demand amount 42, a stored water remaining amount 43 that is an example of the supply amount of water, and the like are set. An input parameter is input to a calculation block 44. Based on an output (OUTPUT) of the calculation block 44, a power distribution device 45 can distribute the electric power of the power generation facility 20 and the like to the water extraction unit 11, the electrolyzing unit 12, the reducing unit 13, and the like.

The oxygen demand amount 42 may be the demand amount of oxygen to be consumed alone for the purpose of the life support 33 and the like. The oxygen demand amount 42 may include the demand amount of oxygen to be used for the chemical reaction with hydrogen for the purpose of the fuel cell 31 and the like. The oxygen demand amount 42 can be calculated based on the remaining amount of the oxygen storage unit 16 and the predicted use of oxygen.

In the following description of a calculation example, “excess amount of oxygen demand” is described as an example of the oxygen demand amount 42. An excess amount X_{O2} of oxygen demand is defined by X_{O2}=Q_{O2}−k×Q_{H2}, where Q_{O2} represents an oxygen demand amount, Q_{H2} represents a hydrogen demand amount, and k represents a ratio of an oxygen amount required for oxidizing a predetermined amount of hydrogen. When the ratio between the Q_{O2} and the Q_{H2} is expressed by a molar ratio, the coefficient k is equal to 1/2. When the ratio between the Q_{O2} and the Q_{H2} is expressed by a mass ratio, the coefficient k is represented by k=(1/2)×[Aᵣ(O)/Aᵣ(H)]≈8 through use of an atomic weight Aᵣ(O)≈16 of oxygen and an atomic weight Aᵣ(H)≈1 of hydrogen.

As a premise of the calculation example, it is assumed that there is an abundance of electric power supplied from the power generation facility 20 and the like. Further, the water-containing regolith 21 is regarded as a valuable resource on the lunar surface, and hence the consumption amount of the water-containing regolith 21, that is, the amount of water to be extracted from the water-containing regolith 21 is set to be suppressed. In this case, it is required to generate oxygen as much as possible by electrolysis of the water supplied from the reducing unit 13 with respect to the desired “excess amount of oxygen demand”.

In view of the foregoing, as a first step S1, the calculation block 44 calculates the required operating rate and required electric power of the reducing unit 13 in accordance with the excess amount of oxygen demand. As a result, the calculation block 44 can determine an electric energy E₁₃ of the reducing unit 13.

Next, as a second step S2, the calculation block 44 calculates the electric power required for electrolysis of the water supplied from the reducing unit 13 in accordance with the operating rate of the reducing unit 13. However, the supply amount of water is an important indicator for the oxygen amount required for the life support, and hence it is required to investigate whether or not to use a whole amount of the water supplied from the reducing unit 13 for electrolysis.

In view of the foregoing, as a third step S3, the calculation block 44 decides whether or not to use the whole amount of the water supplied from the reducing unit 13 for electrolysis based on the stored water remaining amount 43 in the water storage unit 14 and calculates an “electrolysis ratio” as the ratio of water to be used for electrolysis. When the stored water remaining amount 43 is sufficient, the calculation block 44 decides to use the whole amount of the water supplied from the reducing unit 13 for electrolysis, sets the “electrolysis ratio” to 100%, and determines the value calculated in the second step S2 described above directly as an electric energy E₁₂ of the electrolyzing unit 12.

When the stored water remaining amount 43 is not sufficient, as a fourth step S4, the calculation block 44 decides to use a part of the water supplied from the reducing unit 13 for electrolysis and calculates a value less than 100% as the “electrolysis ratio”. The calculation block 44 outputs an amount decreased from the value calculated in the second step S2 described above in accordance with the “electrolysis ratio”, as the electric energy E₁₂ of the electrolyzing unit 12. In addition, the calculation block 44 calculates the amount of water to be extracted from the water-containing regolith 21 in accordance with the ratio obtained by subtracting the “electrolysis ratio” from 100% and determines an electric energy E₁₁ of the water extraction unit 11.

Further, the calculation block 44 may include a step of inspecting whether or not the sum of the electric energies E₁₁, E₁₂, and E₁₃ of the respective units of the substance conversion unit 10 determined as described above exceeds a total power generation amount T. The power distribution device 45 supplies electric power to the water extraction unit 11, the electrolyzing unit 12, and the reducing unit 13, respectively, from the total power generation amount T in accordance with the electric energies E₁₁, E₁₂, and E₁₃ determined by the calculation block 44.

When the power generation amount T is not abundant, the operation of the reducing unit 13 may be suspended, and the electrolyzing unit 12 and the water extraction unit 11 may be preferentially operated. In this case, in the first step S1 described above, the calculation block 44 can determine that the electric energy E₁₁ of the reducing unit 13 is set to zero. In this case, in the second step S2, the calculation block 44 may calculate the electric power required for electrolysis of the water that can be supplied from the water storage unit 14 instead of the water supplied from the reducing unit 13. Further, in the third step S3, the calculation block 44 decides whether or not to use the whole amount of the water supplied from the water storage unit 14 for electrolysis based on the stored water remaining amount 43. When the stored water remaining amount 43 is not sufficient, in the fourth step S4, the calculation block 44 decides to use a part of the water supplied from the water storage unit 14 for electrolysis and calculates a value less than 100% as the “electrolysis ratio”. With this configuration, the calculation block 44 can determine the electric energy E₁₂ of the electrolyzing unit 12 and the electric energy E₁₁ of the water extraction unit 11.

In any of the case in which the power generation amount T is abundant and the case in which the power generation amount T is not abundant, the control unit 40 may decide to use the whole amount of the water that can be supplied to the substance conversion unit 10 for electrolysis when the stored water remaining amount 43 is sufficient, and may decide to extract the water from the water-containing regolith 21 when the stored water remaining amount 43 is not sufficient. With this configuration, the resource of the water-containing regolith 21 can be conserved for a longer period of time by decreasing the amount of water to be extracted from the water-containing regolith 21.

When there is a water source, such as domestic wastewater or treated water thereof from, for example, facilities related to the life support 33, the amount of water based on the water source may be included in the stored water remaining amount 43 in the water storage unit 14. The calculation block 44 may calculate the electric energy of a facility that obtains deionized water suitable for electrolysis from a facility for treating domestic wastewater. The step of obtaining water for electrolysis from other water source may be handled in the same manner as in the step of extracting water from the water-containing regolith 21.

When the water extraction unit 11 is a facility that utilizes solar heat or the like without consuming electric power, the calculation block 44 can determine that the electric energy E₁₁ of the water extraction unit 11 is set to 0 in the fourth step S4 described above. The calculation block 44 can determine the electric energy E₁₃ of the reducing unit 13 and the electric energy E₁₂ of the electrolyzing unit 12 in the same manner as in the first step S1, the second step S2, and the third step S3 described above.

When the use of hydrogen and oxygen obtained from the substance conversion unit 10 as propellants for an object, such as a rocket, is taken into consideration, the control unit 40 may include the demand amount of hydrogen to be used as liquefied fuel as an input parameter. In addition, the control unit 40 may include the electric energy required for operating the liquefaction facility in output parameters.

Although the present invention has been described above based on the preferred embodiment, the present invention is not limited to the above-mentioned embodiment, and various modifications are possible within a scope not departing from the gist of the present invention. As the modifications, there are given the addition, replacement, omission, and other changes of the constituent elements.

During a period in which the demand for oxygen is low, for example, in which the demand for the life support 33 is low, the storage of the metal oxide or the like 23 may be allowed to proceed by mainly operating the water extraction unit 11 and the electrolyzing unit 12 while suspending the operation of the reducing unit 13. In this case, the hydrogen and oxygen generated in the electrolyzing unit 12 may be returned to water in the fuel cell 31.

During a period in which the demand for oxygen is high, for example, in which the demand for the life support 33 is high, the electrolyzing unit 12 and the reducing unit 13 may be mainly operated, and the operation of the water extraction unit 11 may be suspended. With this configuration, hydrogen may be consumed for reduction of the metal oxide or the like 23, and more oxygen may be supplied to the life support 33.

### INDUSTRIAL APPLICABILITY

The present invention can be utilized in various industries related to the lunar surface development. In addition, the present invention can be applied also to the outer space development on a celestial body other than the moon.

### REFERENCE SIGNS LIST

10 substance conversion unit, 11 water extraction unit, 12 electrolyzing unit, 13 reducing unit, 14 water storage unit, 15 hydrogen storage unit, 16 oxygen storage unit, 17 reduced metal or the like, 20 power generation facility, 21 water-containing regolith, 22 dry regolith, 23 metal oxide or the like, 31 fuel cell, 32 electric power, 33 life support, 34 building material, 40 control unit, 41 power generation amount, 42 oxygen demand amount, 43 stored water remaining amount, 44 calculation block, 45 power distribution device, 100 plant

1. A plant on a lunar surface for generating resources from soil on a lunar surface, comprising:
a water extraction unit configured to extract water from a water-containing regolith collected from the soil;
an electrolyzing unit configured to generate hydrogen and oxygen by electrolysis of water;
a reducing unit configured to reduce, with hydrogen, a dry regolith collected from the soil and metal oxide contained in a remaining component obtained by extracting water from the water-containing regolith, to thereby provide a reduced metal;
a hydrogen storage unit configured to store hydrogen generated by the electrolysis;
an oxygen storage unit configured to store oxygen generated by the electrolysis; and
a water storage unit configured to store the water extracted from the water-containing regolith and water obtained in the reducing unit,
wherein a reducing device used in the reducing unit and an extraction device used in the water extraction unit are common in configuration as a device configured to perform heating by focused irradiation of sunlight or electric heat.

2. The plant according to claim 1, further comprising a fuel cell configured to generate electric power from hydrogen and oxygen.

3. The plant according to claim 1, further comprising
a power generation facility.

4. The plant according to claim 1, comprising a control unit configured to control the plant based on at least one of a demand amount or a supply amount regarding at least one kind selected from water, oxygen, hydrogen, and electric power.

5. The plant according to claim 4, wherein the control unit controls the plant in consideration of an amount of oxygen required for a chemical reaction between hydrogen and oxygen and an amount of oxygen required for life support on the lunar surface regarding at least one of the demand amount or the supply amount of oxygen.

6. The plant according to claim 4, wherein the control unit controls the plant in consideration of an amount of hydrogen required for a chemical reaction between hydrogen and oxygen and an amount of hydrogen required for reduction of the metal oxide regarding at least one of the demand amount or the supply amount of hydrogen.

7. The plant according to claim 4, wherein the control unit decides to use a whole amount of water supplied from the reducing unit for the electrolysis when a remaining amount of stored water is sufficient, and decides to extract water from the water-containing regolith when the remaining amount of the stored water is insufficient.

8. (canceled)

9. (canceled)

10. An operation method of a plant for generating resources from soil on a lunar surface, comprising:
extracting water from a water-containing regolith collected from the soil;
generating hydrogen and oxygen by electrolysis of water containing at least the water extracted from the water-containing regolith; and
obtaining a reduced metal by reducing the metal oxide, which is contained in a dry regolith collected from the soil and a remaining component obtained by extracting water from the water-containing regolith, with the hydrogen generated by the electrolysis;
storing hydrogen generated by the electrolysis in a hydrogen storage unit;
storing oxygen generated by the electrolysis in an oxygen storage unit; and
storing the water extracted from the water-containing regolith and water obtained from the reduction of the metal oxide in a water storage unit,
wherein in the plant, a reducing device used for reducing the metal oxide and an extraction device used for extracting water from the water-containing regolith are common in configuration as a device configured to perform heating by focused irradiation of sunlight or electric heat.
